(19) United States
(12) Patent Application Publication
(10) Pub. No.: US 2015/0215392 A1
(43) Pub. Date: Jul. 30, 2015

(54) Method for starting up at least one functional device, and rail vehicle system

(71) Applicant: SIEMENS AKTIENGESELLSCHAFT, MUENCHEN (DE)

(72) Inventor: Juergen Miebs, Eggolsheim (DE)

(21) Appl. No.: 14/423,267

(22) PCT Filed: Jul. 24, 2013
(86) PCT No.: PCT/EP2013/065591

§ 371 Date: Feb. 23, 2015

(30) Foreign Application Priority Data
Aug. 23, 2012 (DE) 10 2012 214 950.3
Jan. 23, 2013 (DE) 10 2013 201 031.1

(51) Int. Cl. H04L 29/08

(52) U.S. Cl. CPC H04L 67/104; H04L 67/12

(57) ABSTRACT

A method starts up a functional device in a first rail vehicle of a vehicle system containing a plurality of rail vehicles. The functional device is operable on the basis of a functional data set. A functional data set is stored in each rail vehicle in order to operate the functional device. The stored set is loaded from a storage unit of the first rail vehicle, and the functional device is operated at least on the basis of the loaded functional data set. When a second rail vehicle which is coupled to the first rail vehicle has functionalities which are not present in the first rail vehicle or are configured differently, the functional data stored in the second rail vehicle advantageously contains information required for operating the functional device in the first rail vehicle while taking into consideration the vehicle-specific functionalities of the second rail vehicle.

The invention relates to a method for starting up at least one functional device in a first rail vehicle of a vehicle system consisting of a plurality of rail vehicles, wherein the functional device is operable on the basis of at least one set of functional data.

In rail passenger transport, along with the conventional train configurations with passenger carriages which are driven by a locomotive, vehicle systems are used which are formed by the coupling of self-driven rail vehicles. Along with the drive, each rail vehicle of a vehicle system has its own control system which must be suitable for both individual operation and combined operation with further rail vehicles. If the rail vehicles in a vehicle system are designed as identical, the vehicle system can be operated as one train unit from one driver's cab without costly adaptation, since the systems in the different rail vehicles are structurally and functionally aligned with one another.

However, the case often occurs where a rail vehicle of one specific type is coupled with a further rail vehicle of a type which, although compatible, differs structurally and/or functionally from the first rail vehicle. This occurs particularly because a rail operator obtains rail vehicles from a vehicle manufacturer in the form of individual batches under the terms of a call-off order. Rail vehicles of an older batch are thus coupled with rail vehicles of a more recent batch which have more or modified functionalities compared with the rail vehicles of the older batch.

The coupling can be implemented in that the rail vehicles of the older batch can be adapted through software to the new functionalities of the rail vehicles of the more recent batch. Furthermore, the rail vehicles of the more recent batch must be configured in such a way that they are suitable for operation with the older rail vehicles. The adaptation of the older rail vehicles often requires a new license, as a result of which a cost is incurred not only for the vehicle manufacturer, but also for the rail operator.

Expressed using a technical term, the rail vehicles of the older batch must be reconfigured. This reconfiguration comprises a reprogramming of the functional device, its communication with a control unit and this control unit itself. This involves at least two groups of experts, who are specialized in the control technology of the rail vehicle on the one hand and in the development of the functional device on the other hand. These processes are particularly time-consuming due to the necessary coordination between the experts.

The object of the invention is to provide a method for starting up at least one functional device in a first rail vehicle of a vehicle system consisting of a plurality of rail vehicles, by means of which an operation of a vehicle system consisting of rail vehicles of different configurations can be achieved at a low adaptation cost.

To do this, it is proposed that at least one set of functional data for operating the functional device is in each case stored in each rail vehicle, at least one of the stored sets is loaded in the first rail vehicle from the allocated rail vehicle, and the functional device is operated at least on the basis of the loaded set of functional data. For this purpose, it can be achieved in the formation of the vehicle system with a plurality of rail vehicles that a plurality of sets of functional data which are in each case specific to the structural and/or functional configuration of the corresponding rail vehicle are made available to the functional device. If the vehicle system is formed from rail vehicles with different configurations, e.g. if a second rail vehicle coupled to the first rail vehicle is structurally and/or functionally provided with functionalities which are not present or are designed differently in the first rail vehicle, the functional data stored in the second rail vehicle appropriately contain information necessary for an operation of the functional device in the first rail vehicle, taking account of the aforementioned vehicle-specific functionalities of the second rail vehicle. Due to the loading of a set of functional data of the second rail vehicle in the functional device of the first rail vehicle, the functional device can accordingly be adapted automatically to the structural and/or functional configuration of the second rail vehicle without the need for a reconfiguration of the functional device, the communication of said device with the rail vehicle control technology and this control technology in the first vehicle.

The functional data are essentially static data which are not modifiable during an operation of the respective rail vehicle. They may, in particular, contain defined parameters and/or templates for running an application of the functional device. They are preferably created before the first starting up of the rail vehicle and are stored in a storage unit on-board the rail vehicle. They can be updated between two operational deployments, wherein the updated functional data are stored only in the storage unit of the respective rail vehicle with no need for an adaptation of the functional device. The functional device is operated on the basis of the functional data in that said data are, in particular, incorporated into an existing software structure by an operating system of the functional device, wherein this software structure is largely unrelated to the respective structural and/or functional configuration of the rail vehicles of the vehicle system. These configurations are advantageously taken into account with this incorporation of the functional data. The software structure present in the functional device is essentially formed from an abstract structure or structure with abstract objects which are “instantiated” by means of the functional data from the different rail vehicles. In comparison with a conventional structure, which must be designed as the largest common denominator for all possible train system configurations and accordingly incurs a high configuration cost, the proposed structure is adapted through a suitable degree of abstraction to these train system configurations. Furthermore, configuration errors can be more simply identified due to the instantiation of abstract objects.

In this context, a “set” of functional data can be understood, in particular, as a file containing the functional data or a bundle of such files.

A “starting up” of the functional device is intended to be understood, in particular, as a procedure which takes place after the mechanical formation of the vehicle system and before the start of deployment of the vehicle system as a train unit. The starting up preferably takes place in conjunction with the “train launch”, in which a system configuration of the rail vehicles required for the operational deployment is set. In this setting procedure, specific parameters and conditions of rail vehicle control system devices are set in such a way that requirements for the operation of the vehicle system as a train unit are met.

According to one preferred embodiment of the invention, it is first determined in the first rail vehicle, before the loading of a stored set of functional data, whether the set needs to be loaded, and the loading is carried out if necessary, as a result of which an unnecessary data transmission can advantageously be avoided. A version of functional data which are already stored in the functional device and a version of corresponding functional data which is available for loading in a rail vehicle are preferably compared here.

It is furthermore proposed that at least one set of functional data serves to form static application elements which are available to the functional device in order to run an application, that dynamic data are transmitted to the functional device during the operation of the vehicle system, and that the running of the application is based on an interworking of the static application elements and the dynamic data. The information necessary for the formation of the static application elements is thus advantageously contained in the functional data stored centrally in the respective rail vehicle. These static application elements, which relate, in particular, to the respective structural and/or functional configuration of the different rail vehicles, which is invariable per se during the operation of the vehicle system, can be generated on the basis of the functional data stored centrally in each rail vehicle. The development of these application elements relating to the respective structural and/or functional configuration of the rail vehicles can be transferred to the production and provision of the centrally stored functional data and no longer relates to the functional device. As a result, vehicles of different types may, for example, in each case have different diagnostic procedures or instruction texts, wherein a modification carried out for one vehicle type requires no corresponding modification for the other vehicle types in a vehicle fleet.

In contrast to the functional data and the application elements formed from these data, the dynamic data are appropriately related to the operation of the vehicle system. They are preferably related to the status or condition of components of the entire vehicle system, which may change during operation. Examples of a status of this type may be an operational capability, a fault-free operation, a fault, a failure, etc. They may furthermore relate to variable driving parameters, such as, for example, a vehicle speed, an acceleration, a performance, a position, etc. The incorporation of the dynamic data is, in particular, independent from a respective signal interface of the different rail vehicles. The modification of a signal interface in one rail vehicle type advantageously requires no adaptation in the vehicles of other rail vehicle types.

The functional data can be stored in the respective rail vehicles in different formats which relate in each case to the nature of the corresponding application element. Functional data may therefore, for example, be text files, image files or executable files which can be directly incorporated by an operating system of the functional device to run the application.

However, an advantageous degree of independence from an operating system of the functional device can be achieved if the functional data for generating the application elements are compiled in the first rail vehicle before the operation of the functional device. The functional data can thus be stored centrally in the respective rail vehicle in a format which is advantageous for loading in the first rail vehicle and, in particular, is the same for the different application elements. After the loading, the functional data are appropriately converted during the compilation into the form of files of different formats which can then be incorporated by an operating system of the functional device to run the application. An updating or a complete modification of the operating system of the functional device can advantageously be carried out without the need for substantial adaptations of the functional data.

In this connection, it is proposed that the functional data are stored and loaded in the form of text files. As a result, the functional data can be stored in a form which is economical in terms of storage space and can be loaded into the first rail vehicle. In order to achieve a particularly low dependence on the operating system of the functional device, it is proposed that the text files are suitable for the platform-independent and implementation-independent exchange of data between computer systems. In particular, text files can be designed as XML (“Extensible Markup Language”) files.

In one particularly advantageous design of the invention, the functional device has a display device, wherein the application elements correspond to display elements available at least for an operation of the display device and a dynamic display is effected on the basis of the available display elements and the dynamic data. Examples of display elements are text information, a background image, an icon of a vehicle component, etc. These display elements, which are formed on the basis of the functional data stored centrally in the rail vehicle, can advantageously be designed during the configuration of the vehicle control system, wherein an incorporation of further experts at the functional device development level is not necessary. In particular, a display element can be modified quickly and simply through a corresponding adaptation of the corresponding functional data.

According to one preferred design of the invention, at least one set of functional data serves to form a link between dynamic data which can be transmitted to the functional device and at least one action with an application element which is to be carried out for these dynamic data. As a result, the configuration of a signal transmission between a unit which generates the dynamic data and the functional device can similarly take place at the centrally stored functional data level. Here, the necessary links are preferably not transmitted together with the dynamic data, but are advantageously available in the form of functional data for retrieval by the functional device.

If the functional device has a display device, wherein the application elements correspond to display elements available at least for an operation of the display device, it is proposed in this connection that a link can be established on the basis of the functional data between dynamic data and one of the following actions: showing or hiding an icon, displaying an icon in a specific color, providing showable text information.

In a further design of the invention, the functional device in the first rail vehicle has an input device to enter control commands, wherein at least one set of functional data of one of the rail vehicles serves to form at least one executable routine which is provided to initiate the performance of a function in this rail vehicle on the basis of the entered control command. Functionalities of a further rail vehicle of the vehicle system can thus be operated from the first rail vehicle, in particular even if said functionalities are not available in the first rail vehicle.

According to one preferred design of the invention, the rail vehicles are interconnected by means of an Ethernet-based communication bus to which the functional device is connected and via which at least the functional data are transmitted. For this purpose, a fast transmission of the functional data can be effected by means of conventional transmission protocols for Ethernet-based networks. For example, the use of the simple FTP protocol (“File Transfer Protocol”) is conceivable. An Ethernet-based communication bus is suitable, in particular, for a transmission of functional data which are stored in the form of XML files.

In this connection, it is proposed that the functional data and the dynamic data are transmitted to the functional device via the communication bus. Here, the dynamic data can be transmitted according to the UDP protocol (“User Data Protocol”), which is suitable, in particular, for an application with an Ethernet-based network.

The utilization of the vehicle control system of the rail vehicles can be optimized in that a data transmission to the functional device and a data transmission from the functional device can be implemented via different buses.

In particular, the data transmission from the functional device is implemented via a further vehicle-internal bus which is designed, in particular, according to the prior art, such as, for example, in the form of an MVB bus (“Multifunction Vehicle Bus”). The load of the data buses which are available as standard, such as MVB buses and WTB buses (“Wire Train Bus”), can advantageously be relieved by means of a data transmission of the functional data and the dynamic data via the Ethernet-based communication bus. Furthermore, a configuration of these buses in relation to the operation of the functional device can advantageously be dispensed with.

In one alternative design, it is conceivable for an Ethernet-based communication bus to be formed merely as a vehicle-internal bus via which at least the functional data are transmitted. The functional data can then be transmitted between the rail vehicles via an existing bus, such as, for example, a WTB bus. In a further, alternative design, it is similarly conceivable to use existing buses only, such as MVB buses within the rail vehicles and a WTB bus between the rail vehicles, for the transmission of the functional data.

Although an increased utilization of these buses may occur, an additional bus does not need to be installed.

Furthermore, a rail vehicle system is proposed, consisting of at least two rail vehicles, with at least one functional device disposed in a first rail vehicle, wherein a storage unit is provided in each case in each rail vehicle in which at least one set of functional data for operating the functional device is stored, the rail vehicles are interconnected by means of a communication bus and the functional device is provided in order to load at least one of the sets of functional data from the allocated rail vehicle and to be operated on the basis of the loaded set of functional data. With regard to the advantageous effects of the proposed vehicle system, reference is made to the above descriptions relating to the method in order to avoid unnecessary repetitions.

An example embodiment of the invention is explained in detail with reference to the drawings, in which:

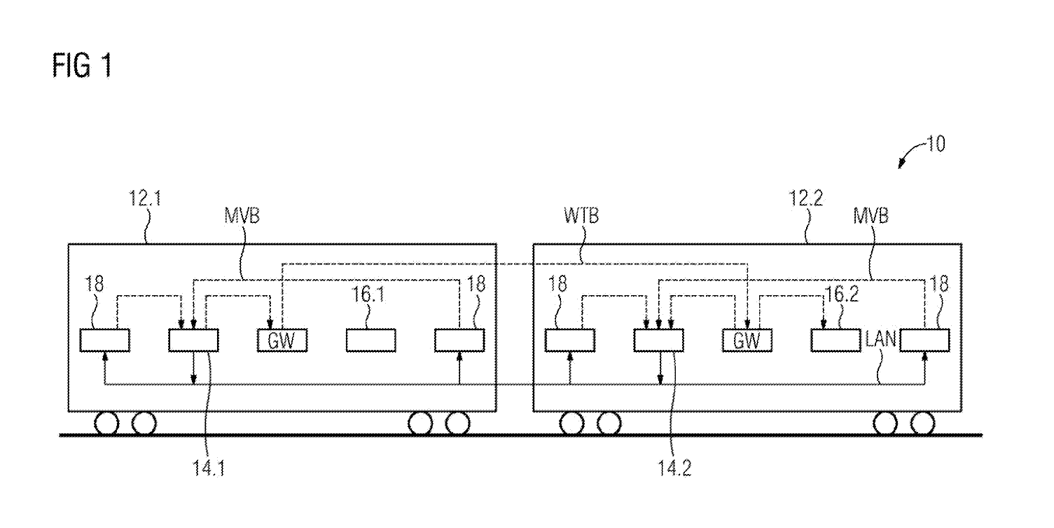

FIG. 1: shows a vehicle system consisting of two rail vehicles coupled to one another and an internal network structure,

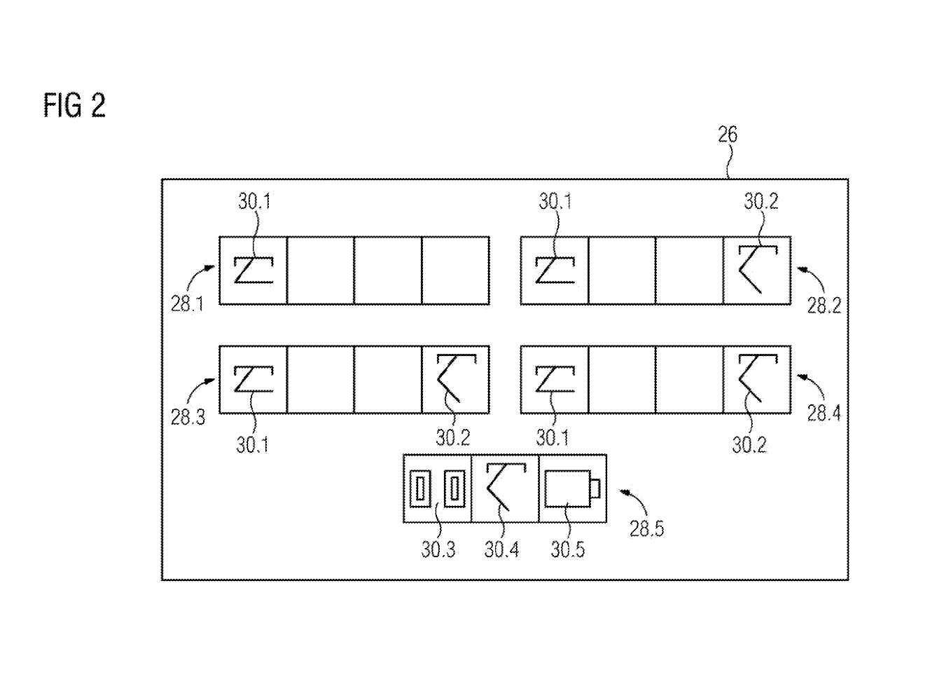

FIG. 2: shows a display device of a functional device connected to the network structure of the rail vehicle driving in the vehicle system,

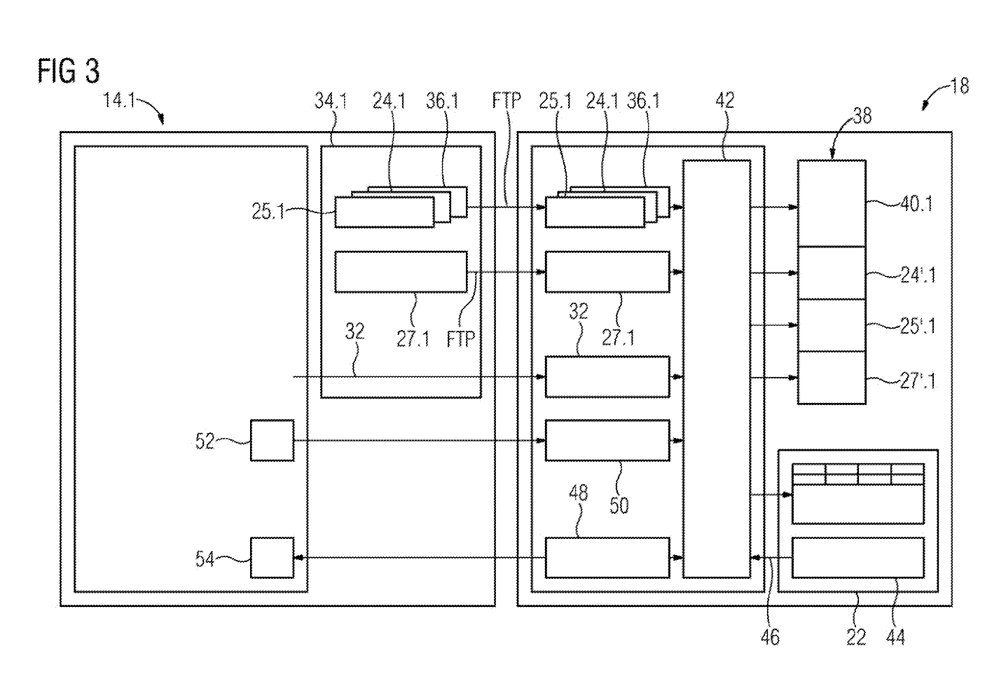

FIG. 3: shows a data transmission between a central control unit of the rail vehicle driving in the vehicle system and the functional device, and

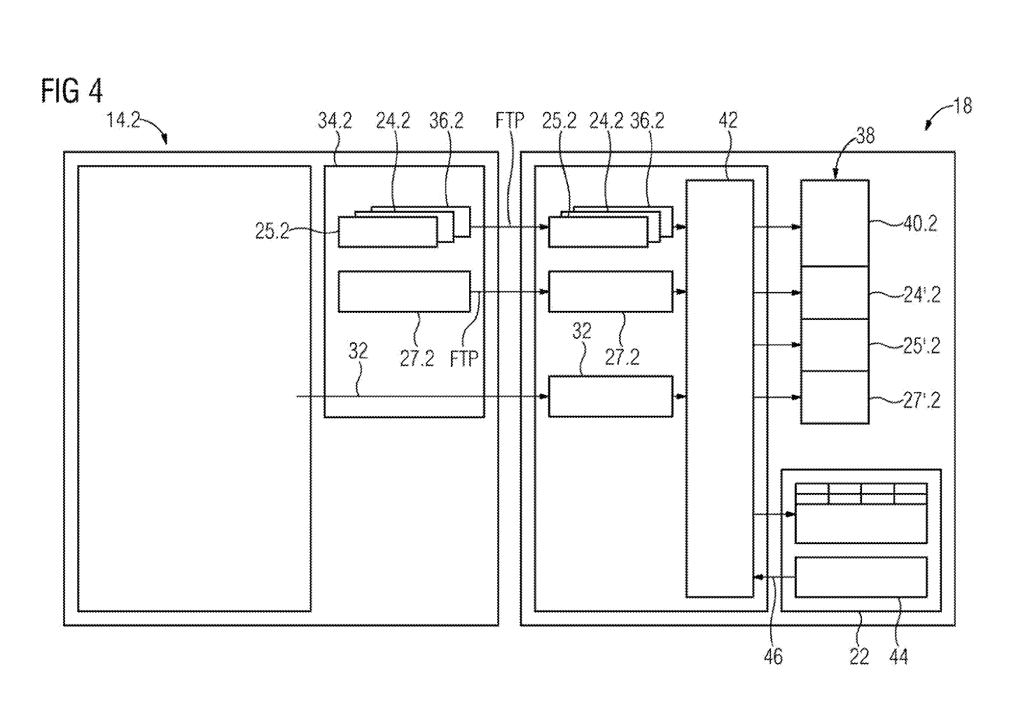

FIG. 4: shows a data transmission between a central control unit of the rail vehicle driven in the vehicle system and the functional device.

FIG. 1 shows a highly schematized side view of a vehicle system 10 which consists of two rail vehicles 12.1, 12.2 coupled to one another, which are designed as multiple units. The rail vehicles 12 may consist of a plurality of carriages. The coupling is preferably effected by means of matching front coupling units (not shown in detail) which are disposed at the head or at the end of the rail vehicles and serve to establish a mechanical coupling automatically between both rail vehicles 12. The two-part design of the vehicle system 10 shown is an example, wherein the method described below is similarly suitable for vehicle systems consisting of three or more rail vehicles 12.

A distinction is made in the text between corresponding units of the rail vehicles 12.1, 12.2 by adding the suffix “.1” and “.2” to the reference number. This suffix is not used if a description applies generally to both units.

Each rail vehicle 12 has a pair of central control units (CCUs) 14, 16 which are provided to control processes in the respective rail vehicle 12 during the operation of the vehicle system 10. In this pair of control units 14, 16, one part is configured as the master and the other part is configured as the slave. In the example embodiment considered, the control unit 14 is designed as the master. Functional devices 18 are connected via control lines to the control units 14, 16. The functional devices 18 can be designed as terminal devices or even as control units to control subsystems of the respective rail vehicle 12.

In the example embodiment, a man-machine communication device which has at least one display device 22 shown in FIG. 2 to output information to a train driver is considered as the functional device 18. This information corresponds, in particular, to status and/or diagnostic information relating to further components of the vehicle system 10. For example, the train driver can be informed that a component is operating trouble-free, is defective, fails, requires a specific action, must be switched on or off or that the component is due for maintenance. The terminal device 18 is also referred to by the technical term “OD terminal” (or “operational and diagnostic terminal”). Each rail vehicle 12 has two such functional devices 18 which are disposed in each case in a driver's cab at the opposite ends of the rail vehicle 12.

The central control units 14, 16 in all rail vehicles 12 of the vehicle system 10 interwork in such a way that the vehicle system 10 can be operated from an occupied driver's cab as one train unit. Along with a trouble-free mechanical coupling via the front coupling units, requirements for the control systems must be met in all rail vehicles 12 of the vehicle system 10 before the train unit is regarded as correctly formed. These requirements may be designated generically as the “system configuration” which must be set before the operation of the vehicle system 10 as a train unit. Following the mechanical coupling, setting procedures are carried out accordingly in the rail vehicles 12, by means of which the aforementioned requirements of the system configuration can be met. The technical term “train launch” is also used for the procedure associated with these settings. The vehicle system 10 can be operated as a train unit only when the train launch is completed.

The method described below relates in particular to the starting up of the functional device 18 in the train launch of the vehicle system 10.

The functional device 18 is operated once the train launch is completed, i.e. during the operation of the vehicle system 10, on the basis of sets 24, 25 and 27 of functional data (see FIGS. 3 and 4). The functional data 24 serve to form static application elements 26, 28, 30 which are designed as display elements and are available to the functional device 18 for the running of a display application. Examples of such application elements are shown in FIG. 2. An application element 26 corresponds to a main window, also referred to as a “form”, in which display windows, also referred to as “frames”, are placed. To explain the image shown in FIG. 2 and indicated by means of the functional device 18, it is assumed that the vehicle system 10 consists of four rail vehicles 12.1 to 12.4. The image displayed contains, in particular, four application elements 28.1 to 28.4 in the form of frames which are allocated in each case to one of the different rail vehicles 12. A schematic representation of the allocated rail vehicle can be seen in each frame, wherein the individual carriages are similarly shown. A further application element 28.5 is provided in the form of a frame, by means of which the operator can select a specific function to be tested. In the example embodiment considered, the “pantograph” function is selected, wherein, in each of the rail-vehicle-related frames or application elements 28.1 to 28.4, the respective status of the allocated pantograph is displayed. The status is displayed by means of application elements 30.1 and 30.2 in the form of different icons. The testing of further functions such as, for example, the opening and closing procedure of doors or state of charge of the on-board battery is obviously possible, wherein the different functions are displayed by means of application elements 30.3, 30.4, and 30.5 in the form of icons.

In the running of the display application, dynamic data 32 containing information on the status of vehicle components are regularly transmitted to the functional device 18 during the operation of the vehicle system 10. The display by means of the display device 22 is provided through an interworking of the static application elements 26, 28, 30 with the dynamic data 32. In the example considered, shown in FIG. 2, dynamic data 32 are transmitted to the functional device 18 with information relating to the operating state of the pantographs. A link exists between the dynamic data and specific application elements 30 or the icons, wherein, if information transmitted by the dynamic data 32 is present, an allocated application element 30.1 or 30.2 representing an active or inactive pantograph is shown. In a further example, an application element 30, i.e. the icon of a vehicle door, can be displayed in red on the basis of dynamic data 32 which contain, for example, the information “second door at the back on the left in the first driven rail vehicle defective”. Moreover, further dynamic data 32 can cause the opening of an application element 28 by showing a window with an information text. The link between the dynamic data 32 and specific executable routines or actions is explained below.

A network structure of the vehicle system 10 is shown in FIG. 1. A distinction is made between vehicle-internal and system-wide buses. Within a rail vehicle 12 of the vehicle system 10, the functional devices 18 and the central units 14, 16 are networked with one another via a bus MVB. This bus MVB, which is shown by dashed lines in the figure, corresponds to a “Multifunction Vehicle Bus”. This fieldbus, which serves to transmit commands within a rail vehicle, is known from the prior art and is therefore not explained in detail here. The vehicle-internal buses MVB of the rail vehicles 12 are furthermore interconnected via a further bus WTB. This bus, which is shown by dotted-and-dashed lines, is designed as a fieldbus which, together with the buses MVB of the rail vehicles 12, forms a system-wide communication network. It corresponds to a “Wire Train Bus” known from the prior art, which is not explained in detail here. The connection via the bus WTB is established in each rail vehicle 12 via an interface unit GW which is networked with the local control units 14, 16 and the local functional devices 18 by means of the bus MVB. A further system-wide communication bus LAN, to which the control units 14, 16 and the functional devices 18 are connected, is furthermore provided. The communication bus, which is shown by means of a struck-through line, is formed on an Ethernet basis.

The starting up of the functional device 18 will now be explained in detail with reference to FIGS. 1, 3 and 4. It is assumed here that the driver's cab disposed on the left in FIG. 1 is occupied. The rail vehicle 12.1 corresponds accordingly to the driving rail vehicle of the vehicle system 10. The further rail vehicle 12.2 is designated as the driven rail vehicle. The description below is restricted to the starting up of the functional device 18 in the occupied driver's cab, but applies to all functional devices 18 of the same type in the entire vehicle system 10.

The functional data necessary for the operation of the functional device 18 are stored in a storage unit in each rail vehicle 12. In particular, the sets 24.1, 25.1 and 27.1 of functional data of the driving rail vehicle 12.1 are stored in a storage unit 34.1 of the control unit 14.1 (also referred to as the “Master CCU”) in the driving rail vehicle 12.1 (FIG. 3). Sets 24.2, 25.2 and 27.2 of functional data are stored in the driven rail vehicle 12.2 in a storage unit 34.2 of the control unit 14.2 (FIG. 4).

The sets 24.1, 25.1, 27.1 and 24.2, 25.2, 27.2 are vehicle-specific, i.e. they depend on the structural and/or functional configuration of the respective rail vehicle 12. In the design considered, it is assumed that the rail vehicles 12.1, 12.2 are compatible with one another, but have a different temporal ranking in terms of their manufacture. It is assumed that the driven rail vehicle 12.2 has a younger temporal ranking than the driving rail vehicle 12.1. The driven rail vehicle 12.2 differs structurally and/or functionally from the driving rail vehicle 12.1 in that it has functional devices which are not present in the driving rail vehicle 12.1 and/or that specific functional devices have functionalities which are not present in the corresponding functional devices of the driving rail vehicle 12.1. For example, the rail vehicles 12.1 and 12.2 may have a different number of carriages and/or they may have different air conditioning units. The sets 24.1 and 24.2 in the different rail vehicles 12.1 and 12.2 therefore differ from one another, since they were created on the basis of a different rail vehicle configuration. The same applies to the sets 25 and 27. The technical term “configuration” is also used for the creation of configuration-specific functional data of this type. The sets 24, 25, 27 of functional data are configured before the first starting up of a rail vehicle 12 and are stored in the storage unit 34. They can be updated regularly between operational deployments of the rail vehicle 12. Configuration data are not modified during an operational deployment of the rail vehicle 12. Furthermore, a file 36 containing information on the version of the sets 24, 25, 27 of functional data available in the storage unit 34 is stored in the storage unit 34.

When the functional device 18 is started up in connection with the train launch of the vehicle system 10 as a train unit, a message, also referred to as a telegram, is transmitted in a first step from all control units 14 of the vehicle system 10 to the functional device 18. This message contains, inter alia, information on the number of rail vehicles 12 forming the vehicle system 10. In the example considered, the functional device 18 receives the information that the vehicle system is formed by 2 rail vehicles 12.

In a further step, the functional device 18 loads the configuration file 36.1 from the storage unit 34.1 of the driving rail vehicle 12.1. The functional device 18 compares this configuration file 36.1 with a configuration file 40.1 stored in a storage unit 38 of the functional device 18. If a match is found, the functional device 18 is operated on the basis of sets 24′.1, 25′.1, 27′.1 of functional data which were loaded in an earlier starting up and are already stored in the storage unit 38.

If no match is found, the sets 24.1, 25.1, 27.1 are loaded from the storage unit 34.1 of the control unit 14.1 of the functional device 18 and are stored in the local storage unit 38. The loading procedure is initiated and controlled by means of a loading unit (not shown in detail). The functional device 18 is then operated on the basis of these new sets 24.1, 25.1, 27.1 of functional data.

The aforementioned application elements are then formed on the basis of the set 24.1 or, where relevant, the set 24′.1, by means of a calculation unit 42 of the functional device 18. Image files and text files in particular are generated from these functional data and can then be incorporated by the operating system of the functional device 18 to run the display application. The handling of the sets 25.1 and 27.1 of functional data is described below.

With reference to the example illustration in FIG. 2 and, in particular, the application elements 26, 28, 30, an application structure which is formed from abstract objects or abstract shapes, frames and images is present in the functional device 18, wherein these objects are instantiated on the basis of the functional data of the set 24.1 or 24′.1 of the different rail vehicles 12 of the vehicle system 10. The positioning or showing of status displays is effected on the basis of the vehicle-specific functional data which are incorporated into the abstract application structure of the functional device 18, and is advantageously not predefined by a fixed application structure in the functional device 18. A fixed application structure of this type must take account of all possible train system configurations and accordingly incurs a high configuration cost.

The procedure described above is repeated for the driven rail vehicle 12.2. If the vehicle system 10 consists of more than two rail vehicles 12, the procedure is repeated for each rail vehicle 12. This is explained with reference to FIG. 4, in which the data communication between the control unit 14.2 and the functional device 18 is shown.

The versions of the sets of functional data in the functional device 18 and in the storage unit 34.2 in the driven rail vehicle 12.2 are first compared by means of the configuration files 36.1 and 40.2. If no match is found, the sets 24.2, 25.2, 27.2 are loaded by the functional device 18 of the driving rail vehicle 12.1 from the local storage unit 34.2 in the driven rail vehicle 12.2.

Application elements for running the display application of the display device 22 are then generated from these functional data allocated to the driven rail vehicle 12.2. As described above, the driven rail vehicle 12.2 has functionalities which are not present in the driving rail vehicle 12.1. With the transmission of the functional data from the driven rail vehicle 12.2, the functional device 18 is able to output information which is allocated to these functionalities of the driven rail vehicle 12.2. This facility is provided without the need to carry out a reconfiguration of data in the older rail vehicle 12.1.

After the functional device 18 has been started up, messages with dynamic data 32 are regularly transmitted to the functional device 18, as described above. These messages are actively generated and transmitted by the control units 14.1, 14.2, on the basis of messages which have been transmitted from a specific functional component to the respective control unit 14 via the local bus MVB. The messages from the control units 14.1, 14.2 containing the dynamic data 32 are sent via the communication bus LAN. In the design considered, the messages are sent with the dynamic data 32 according to the UDP (User Data Protocol) network protocol.

The sets 24, 25, 27 of functional data are similarly loaded via the communication bus LAN. The functional data are stored in the storage units 34 of the respective rail vehicles 12 in a text form which is independent from the operating system of the functional device 18 that is used. In particular, the functional data are stored in XML (eXtensible Markup Language) format and are loaded in this form by the functional device 18, in particular by means of the FTP protocol, as shown in FIGS. 3 and 4. The XML files are handled by means of the calculation unit 42, which can generate the aforementioned application elements from said files (also referred to as the “XML parser”). In this connection, a set of functional data may be an XML file or a bundle of a plurality of XML files which are thematically linked with one another.

As described above, the display of information is implemented through an interworking of static application elements 26, 28, 30 on the basis of the functional data with the dynamic data 32. The set 25 of functional data contains instructions for establishing a link between specific dynamic data 32 and at least one action with an application element which is to be carried out for these dynamic data 32. With regard to the display application, the action may be, for example, showing or hiding a specific icon, displaying an icon in a specific color, providing text information which can be shown, etc. On the basis of the set 25 of functional data, sequence codes are produced by means of the calculation unit 42 for routines which are to be executed in each case for specific types of dynamic data. These functional data are also referred to as “link instructions”.

The functional device 18 furthermore has an input device 44 by means of which the traction unit can enter control commands 46. The input device 44 may, in particular, be combined with the display device 22 in the form of a touch display. These control commands 46 are transmitted from the functional device 18 to the local control unit 14.1 via the local bus MVB, in fact via an MVB transmit unit 48 of the functional device 18 and an MVB receive unit 54 of the control unit 14.1. The control commands are then transmitted from the control unit 14.1 to a target component in the driving rail vehicle 12.1 or, via the bus WTB, to a target component in the driven rail vehicle 12.2. The remote control of the target component in the driving rail vehicle 12.1 or in the driven rail vehicle 12.2 is implemented, in particular, by means of an executable routine of the functional device 18. This routine is formed on the basis of the set 27 of functional data, as described above for the further sets 24 and 25. Since the functional device 18 may, in particular, have a set 27.2 of functional data which are specific to the driven rail vehicle 12.2, functionalities of the driven rail vehicle 12.2 which are not present or are designed differently in the driving rail vehicle 12.1 can be operated via the input device 44.

The functional device 18, as a functional component of the rail vehicle 12.1, is furthermore networked with the control unit 14.1 via the bus MVB and has an MVB receive unit 50 via which it receives messages which are generated by an MVB transmit unit 52 of the control unit 14.

1-15. (canceled)

16. A method for starting up at least one functional device in a first rail vehicle of a vehicle system containing a plurality of rail vehicles, the functional device being operable on a basis of at least one set of functional data, which comprises the steps of:
storing at least one set of functional data for operating the functional device in each case in each of the rail vehicles resulting in a plurality of stored sets of functional data;
loading at least one of the stored sets of functional data in the first rail vehicle from a selected rail vehicle and therefore defining a loaded set of functional data; and
operating the functional device on a basis of the loaded set of functional data.

17. The method according to claim 16, wherein in the first vehicle, before the loading of a stored set of functional data, determining whether the stored set needs to be loaded, and a loading is carried out if necessary.

18. The method according to claim 16, which further comprises transmitting dynamic data to the functional device during an operation of the vehicle system, the at least one set of functional data serves to form static application elements which are available to the functional device to run an application, and a running of the application is based on an interworking of the static application elements and the dynamic data.

19. The method according to claim 18, which further comprises compiling the functional data for generating the static application elements in the first rail vehicle before an operation of the functional device.

20. The method according to claim 19, which further comprises storing and loading the functional data in a form of text files.

21. The method according to claim 18, wherein the functional device has a display device, wherein the static application elements correspond to display elements available at least for an operation of the display device and a dynamic display is affected on a basis of available ones of the display elements and the dynamic data.

22. The method according to claim 18, wherein the at least one set of functional data serves to form a link between the dynamic data which are transmitted to the functional device and at least one action with a static application element which is to be carried out for the dynamic data.

23. The method according to claim 21, which further comprises establishing a link on a basis of the functional data between the dynamic data and one of the following actions: showing or hiding an icon, displaying an icon in a specific color, or providing showable text information.

24. The method according to claim 16, wherein the functional device in the first rail vehicle has an input device to enter control commands, wherein the at least one set of functional data of one of the rail vehicles serves to form at least one executable routine which is provided to initiate a performance of a function in the rail vehicle on a basis of an entered control command.

25. The method according to claim 18, which further comprises interconnecting the rail vehicles by means of an Ethernet-based communication bus to which the functional device is connected and via which at least the functional data are transmitted.

26. The method according to claim 18, which further comprises transmitting the functional data and the dynamic data to the functional device via a communication bus.

27. The method according to claim 16, which further comprises implementing a data transmission to the functional device and a data transmission from the functional device via different buses.

28. The method according to claim 26, which further comprises implementing a data transmission from the functional device via a further vehicle-internal bus.

29. A rail vehicle system, comprising:
at least two rail vehicles;
at least one functional device disposed in a first rail vehicle of said at least two rail vehicles;
storage units having sets of functional data, one of said storage units disposed in each case in each of said rail vehicles and each having at least one of said sets of functional data for operating said functional device; and
a communication bus interconnecting said rail vehicles, said functional device loading at least one of said sets of functional data from a selected one of said rail vehicles and said function device is operated on a basis of a loaded set of functional data.

30. The rail vehicle system according to claim 29, wherein said communication bus is an Ethernet based design.
